(19) United States
(12) Patent Application Publication
(10) Pub. No.: US 2008/0264394 A1
(43) Pub. Date: Oct. 30, 2008

(54) Method and System for Detecting Fuel Type

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/110,043

(22) Filed: Apr. 25, 2008

Related U.S. Application Data
(60) Provisional application No. 60/914,445, filed on Apr. 27, 2007.

(51) Int. Cl. F02M 43/00; F02D 19/06

(52) U.S. Cl. 123/575; 701/103

(57) ABSTRACT

A fuel detector in communication with an engine control unit and a sensor identifies one of a first and a second fuel type in response to a sensor input. The engine control unit is configured to provide a first fuel injector pulse width in response to first fuel identification by the fuel detector and a second fuel injector pulse width in response to second fuel identification by the fuel detector. The pulse width signal is optimized for a gasoline blend, while the second pulse width signal is optimized for an E85 fuel blend. The second pulse width is from about 25% to 27% greater than the first pulse width.

### RELATED APPLICATIONS

The present application is a Continuation-in-Part of U.S. Ser. No. 60/914,445 and it claims a priority to the provisional's Apr. 27, 2007 filing date. The present application incorporates the subject matter disclosed in ('445) as if it is fully rewritten herein.

### BACKGROUND OF THE INVENTION

1. Field of the Invention

The present invention relates to systems for the controlled combusting of fuels, and, more particularly, to internal combustion engine systems configured to operate on multiple types of fuel.

2. Background of the Invention

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control, which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

However, conventional internal combustion gasoline or diesel engines are designed to operate on specifications that limit the possibilities of using alternative fuels. More particularly, fuel injector settings for conventional fuels will not generally produce acceptable engine performances when used with alternative fuels. In some examples, a violation of governmental emissions standards may result. Thus, use of alternative flues requires application of appropriate and divergent engine operating specifications.

It is known for a user to manually alter engine settings or to select alternative engine operating specifications when an alternative fuel is used; however, manual selections may be in error due to mistakes in fuel identity or to changes in fuel specifications unknown to the user. Poor or prohibited vehicle performance may result through no intentional fault of the use. What is needed is a method or a system that addresses the problems discussed above, e.g., a method that enables a conventional automobile to efficiently use both conventional petroleum fuel blends and alternative fuel through correctly identifying the fuel type and applying the appropriate operating parameters.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system; and,

FIG. 2 illustrates portions of an automobile fuel injector system in accordance with a preferred embodiment of the present invention;

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

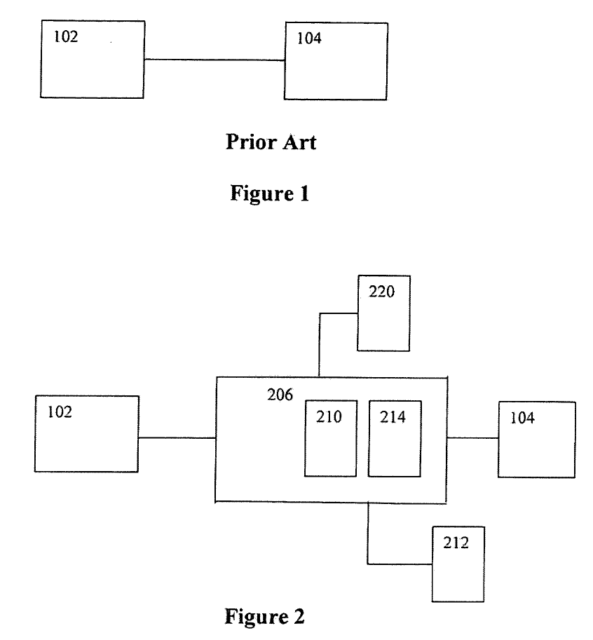

Referring now to FIG. 1, a gasoline internal combustion engine control unit (ECU) 102 is shown in communication with and configured to control a conventional automobile fuel injector component 104. The ECU 102 may also control other automobile systems, e.g., ignition timing and transmission systems (not shown). The ECU is sometimes referred to as an Engine Control Module (ECM) or a Powertrain Control Unit/Module (PCU, PCM). The fuel injector component 104 comprises a plurality of electronically controlled valves with at least one valve provided for each engine cylinder. The valves are each supplied with pressurized fuel by a fuel pump (not shown). The valves are configured to open and close many times per second. The amount of fuel supplied to the engine is determined by the amount of time the fuel injector stays open, called the “pulse width”. The length of time is controlled by pulse width signals controlled by the ECU.

The ECU 102 pulse width signals control the amount and rate of fuel injected into each engine combustion chamber, thereby controlling the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

The ECU 102 monitors the mass of air entering the engine, the amount of oxygen in the exhaust and other engine system performances. The ECU 102 uses one or more formula (s) and a large number of lookup tables to determine an appropriate pulse width for a given operating condition, avoiding too-rich and too-lean AFRs by increasing or decreasing fuel injector 104 pulse widths in real-time in a closed-loop control system. The ECU 102 generally computes more than 100 parameters, each having its own lookup table, and some of the parameters even change over time in order to compensate for changes in the performance of engine components, s.a., e.g., a catalytic converter. Depending on the engine speed, the ECU 102 performs these calculations over a hundred times per second.

Problems arise if the ECU 102 is used with alternative fuels. For example, E85 fuel combustion generates lower energy as measured in British Thermal Units (BTUs) than gasoline fuel blends, and thus higher pulse widths are required to generate comparable engine performances under similar operating parameters. And reconfiguring the ECU 102 to produce appropriate pulse width signals for more than one anticipated fuel blend is not practical in view of the complex computational demands placed upon the limited available ECU 102 processor resources for even one fuel type.

FIG. 2 provides an alternative fuel injector control system according to the present invention, wherein an automatic fuel detector 206 is provided interposed between the ECU 102 and the fuel injector component 104. The fuel detector 206 is configured to detect a fuel type, wherein the detected fuel type may be communicated to an ECU 102 configured to select and output fuel injector pulse width signals appropriate to the detected fuel to the fuel injectors 104, to thereby efficiently operate the fuel injectors 104 on one or more alternative fuels. Alternatively, the fuel detector 206 or another component (not shown) may modify the ECU 102 pulse width outputs to generate modified pulse widths to the fuel injectors 104 for efficient alternative fuel operation. The fuel detector 206 may be programmed or otherwise configured by a manufacturer, an after-market retailer or installer, or by some other service provider. It may also be subsequently re-programmed as required to provide optimal fuel injector settings for one or more specified alternative fuels.

The fuel detector 206 is thus configured to actively detect and identify the fuel being used in order to enable ECU 102 fuel injector pulse width modifications without any owner/operator input requirements. The modified pulse width signals are configured to optimize engine performance for the identified alternative fuel. Thus a conventional automobile incorporating the fuel detector 206 is enabled to use conventional gasoline or one or more alternative fuels. The fuel detector 206 automatically switches engine performance between conventional and alternative fuel modes in response to monitoring the fuel used.

In one embodiment, the fuel detector 206 comprises at least one fuel pressure monitor 210 in communication with at least one fuel system pressure sensor 212. As different fuels, s.a., e.g., Ethanol and gasoline, have different viscosities, observing fuel system pressures enables the fuel detector 206 to distinguish and identify each alternative fuel. Thus, in one example configured for E85 and gasoline fuels, a precision fuel system pressure sensor 212 communicates with a microprocessor-based fuel pressure monitor 210 configured to measure fuel pressure relative to engine RPM. The fuel pressure monitor 210 observes fuel pressures at one or more engine RPM and stores the associated fuel pressure/RPM parameters in a non-volatile memory (e.g., an EPROM) 214. In some embodiments, the fuel pressure monitor 210 will compare observed fuel pressure/RPM values to values already stored in the memory 214 to thereby identify the fuel in use. Alternatively, after filling a fuel tank with a fuel type, an operator may press a calibration button 220, wherein the fuel pressure monitor 210 will observe and store observed fuel pressure/RPM values for future reference in identifying and distinguishing fuel types.

Thus in one aspect, by knowing an RPM and an associated current flow to the fuel pump, the fuel detector 206 can automatically detect which fuel is being used by the vehicle engine system. The fuel injector pulse widths can be modified accordingly. In one example, when a conventional gasoline blend is detected by the fuel detector 206, conventional gasoline pulse width signals are sent to the fuel injectors 104. Alternatively, when E85 is detected, the pulse width signals are modified by widening the pulse widths by from about 25% to about 27% before they are sent to the fuel injectors 104.

While shown and described herein as methods and systems for implementing the recognition of fuel types and/or responsive selection of fuel injector control signal outputs, it is understood that the invention further provides various alternative embodiments. For example, in one embodiment, the invention provides a computer-readable/usable medium 214 that includes computer program code to enable a computer infrastructure to provide recognition of fuel types and/or responsive selection of fuel injector control signal outputs. To this extend, the computer-readable/usable medium includes program code that implements each of the various process stems of the invention.

It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 214 (e.g., a fixed disk, a read-only memory, a random access memory, a cache memory, etc.), and/or as a data signal (e.g., a propagated signal) traveling over a network (e.g. during a wired/wireless electronic distribution of the program code).

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Still yet, any of the components of the present invention could be deployed, managed, serviced, etc., by a service provider who offers to manage fuel injector settings through the components and steps described above. In another embodiment, the invention provides a business method that performs the process steps of the invention on a subscription, advertising and/or fee basis. In this case, the service provider can create, maintain, and support, etc., a fuel detector infrastructure 206 that performs the process steps of the invention, for one or more customers. In return, the service provider can receive payment from the customer(s) under a subscription and/or fee agreement and/or the service provider can receive payment from the sale of advertising content to one or more third parties.

Having thus described the invention what is claimed as new and desired to be secured by Letters Patent is as follows:

1. A system, comprising:
an engine control unit configured to provide a fuel injector pulse width signal to a fuel injector component;
a sensor installed in a vehicle fuel system; and
a fuel detector in communication with the engine control unit and the sensor, the fuel detector is configured to identify one of a first and a second fuel type in response to a sensor input;
wherein the engine control unit is configured to provide a first fuel injector pulse width in response to first fuel identification by the fuel detector and a second fuel injector pulse width in response to second fuel identification by the fuel detector; and,
wherein the second pulse width is greater than the first pulse width.

2. The system of claim 1, wherein the pulse width signal is optimized for a gasoline blend, and wherein the second pulse width signal is optimized for an E85 fuel blend.

3. The system of claim 1, wherein the second pulse width is from about 25% to 27% greater than the first pulse width.

4. The system of claim 3, further comprising a non-volatile memory in communication with the fuel detector.

5. The system of claim 4, wherein the fuel detector is a fuel pressure monitor and the sensor is an inline pressure sensor installed in a fuel system, the fuel pressure monitor is configured to compare observed fuel pressure/RPM values to values stored in the memory.

6. The system of claim 4, wherein the fuel detector is a current monitor and the sensor is a current sensor installed inline with an electric fuel pump, the current monitor is configured to compare observed current draw/RPM values to values stored in the memory.

7. A method, comprising the steps of:
observing a fuel parameter at an engine RPM;
comparing the observed fuel parameter at the observed RPM to a plurality of fuel parameter-RPM values, each value associated with one of a plurality of fuel types; and,
identifying a fuel type from the plurality of fuel types from a correlation of the observed fuel parameter at the observed RPM to one of the plurality of fuel parameter-RPM values.

8. The method of claim 7, wherein the fuel parameter is a fuel pressure.

9. The method of claim 7, wherein the fuel parameter is a fuel pump current draw.
